(19) United States
(12) Patent Application Publication
(10) Pub. No.: US 2016/0240317 A1
(43) Pub. Date: Aug. 18, 2016

(54) MULTILAYER CERAMIC ELECTRONIC COMPONENT

(71) Applicant: SAMSUNG ELECTRO-MECHANICS CO., LTD., Suwon-Si (KR)

(72) Inventors: Chi Hyoun RO, Suwon-Si (KR); Min Jee CHOO, Suwon-Si (KR); Jong Hoon KIM, Suwon-Si (KR); Sung Ae KIM, Suwon-Si (KR); Chang Hoon KIM, Suwon-Si (KR); Jong Ho LEE, Suwon-Si (KR); Hyo Jung KIM, Suwon-Si (KR)

(21) Appl. No.: 14/883,573

(22) Filed: Oct. 14, 2015

(30) Foreign Application Priority Data
Feb. 16, 2015 (KR) 10-2015-0023516

(51) Int. Cl. H01G 4/30; H01G 4/012; H01G 4/12

(52) U.S. Cl. CPC H01G 4/30; H01G 4/12; H01G 4/012

(57) ABSTRACT

A multilayer ceramic electronic component includes a ceramic body having a plurality of dielectric layers and internal electrodes having lead portions narrower than capacitance portions, the first and second external electrodes and dummy electrodes, wherein the first and second external electrodes disposed on both end surfaces of the ceramic body in the length direction, to be connected to the first and second lead portions, respectively, and dummy electrodes disposed on positions of margin portions of the dielectric layers corresponding to the first and second lead portions, to be spaced apart from the first and second internal electrodes, in a width direction of the ceramic body.

### CROSS-REFERENCE TO RELATED APPLICATION

This application claims the priority and benefit of Korean Patent Application No. 10-2015-0023516 filed on Feb. 16, 2015, with the Korean Intellectual Property Office, the disclosure of which is incorporated herein by reference.

### BACKGROUND

The present disclosure relates to a multilayer ceramic electronic component.

Examples of electronic components which use ceramic material include capacitors, inductors, piezoelectric elements, varistors, thermistors, and the like.

A multilayer ceramic capacitor (MLCC), a ceramic electronic component, may be used in various electronic apparatuses due to advantages such as a small size, high capacitance, and ease of mounting.

For example, a multilayer ceramic capacitor is a chip-type condenser mounted on boards of several electronic products such as display devices such as liquid crystal displays (LCDs), plasma display panels (PDPs), and the like, computers, personal digital assistants (PDAs), and mobile phones, to allow electricity to be charged therein or discharged therefrom.

The multilayer ceramic capacitor may have a structure in which a plurality of dielectric layers and internal electrodes disposed between the dielectric layers and receiving different polarities are alternately disposed, and an empty space is present in a portion of the dielectric layer on which the internal electrode is not formed as a margin portion.

When a plurality of dielectric sheets are stacked and compressed during a process of manufacturing a multilayer ceramic capacitor, a dielectric material contained in cover layers and active layers flows, and thus density thereof may become uniform.

In this case, the margin portion in the dielectric layer is a portion at which a step is generated in the dielectric layer, and in a case in which a step size is increased, the internal electrode and a dielectric material in a portion of the dielectric sheet on which the internal electrode is formed fill the margin portion while moving toward the margin portion. In this case, as amounts of the moved dielectric material and internal electrode are increased, a portion of the dielectric sheet of which a thickness is partially decreased is instead increased, and thus withstanding voltage characteristics of a product may be deteriorated.

Particularly, in a case in which lead portions of the internal electrodes exposed in a length direction of a ceramic body are formed to be narrower than capacitance portions of the internal electrodes, since a step of the ceramic body is further increased at a position corresponding to the lead portion, the withstanding voltage characteristics of the product may be further deteriorated.

### SUMMARY

An aspect of the present disclosure may provide a multilayer ceramic electronic component in which withstanding voltage characteristics may be improved by including internal electrodes having lead portions narrower than capacitance portions to decrease a step generated in a margin portion of a ceramic body in a length direction.

According to an aspect of the present disclosure, a multilayer ceramic electronic component may include internal electrodes having lead portions narrower than capacitance portions. Here, dummy electrodes may be disposed on positions of margin portions of dielectric layers corresponding to the lead portions, to be spaced apart from the internal electrodes, in a width direction of the dielectric layer.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a multilayer ceramic electronic component according to an exemplary embodiment in the present disclosure;

FIG. 2 is a cross-sectional view taken along line A-A′ of FIG. 1;

FIG. 3 is a perspective view of the multilayer ceramic electronic component of FIG. 1 in which external electrodes are omitted;

FIG. 4 is an exploded plan view of a stacked structure of the first and second internal electrodes in FIG. 1;

FIG. 5 is a plan view of first and second internal electrodes overlapping each other in FIG. 1;

FIG. 6 is a plan view of dummy electrodes of a multilayer ceramic electronic component according to another exemplary embodiment in the present disclosure;

FIG. 7 is a perspective view of dummy electrodes of a multilayer ceramic electronic component according to another exemplary embodiment in the present disclosure;

FIG. 8 is a plan view of the dummy electrodes of the multilayer ceramic electronic component according to another exemplary embodiment in the present disclosure;

FIG. 9 is a plan view of dummy electrodes of a multilayer ceramic electronic component according to another exemplary embodiment in the present disclosure;

FIG. 10 is a perspective view of dummy electrodes of a multilayer ceramic electronic component according to another exemplary embodiment in the present disclosure;

FIG. 11 is a plan view of dummy electrodes of a multilayer ceramic electronic component according to another exemplary embodiment in the present disclosure;

FIG. 12 is a plan view of dummy electrodes of a multilayer ceramic electronic component according to another exemplary embodiment in the present disclosure;

FIG. 13 is a plan view of dummy electrodes of a multilayer ceramic electronic component according to another exemplary embodiment in the present disclosure;

FIG. 14 is a plan view of dummy electrodes of a multilayer ceramic electronic component according to another exemplary embodiment in the present disclosure; and

FIG. 15 is a plan view of dummy electrodes of a multilayer ceramic electronic component according to another exemplary embodiment in the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

A multilayer ceramic electronic component, according to an exemplary embodiment, may include internal electrodes having lead portions narrower than capacitance portions, wherein dummy electrodes are disposed to be spaced apart from the internal electrodes on positions of margin portions of dielectric layers corresponding to the lead portions in a width direction of the dielectric layer.

The dummy electrodes may be exposed to one surface of a ceramic body in a width direction thereof, and inner end portions of the exposed portions of the dummy electrodes in a length direction of the ceramic body may be positioned on the same virtual line as an end portion of the capacitance portion in the length direction thereof. Therefore, the dummy electrodes may serve to recognize a position of a margin of the ceramic body in the length direction.

As another example, the dummy electrodes may be exposed to one surface of a ceramic body in the length direction, and inner end portions of the exposed portions of the dummy electrodes in the width direction of the ceramic body may be positioned on the same virtual line as an end portion of the capacitance portion in the width direction thereof. Therefore, the dummy electrodes may serve to recognize a position of the margin of the ceramic body in the width direction.

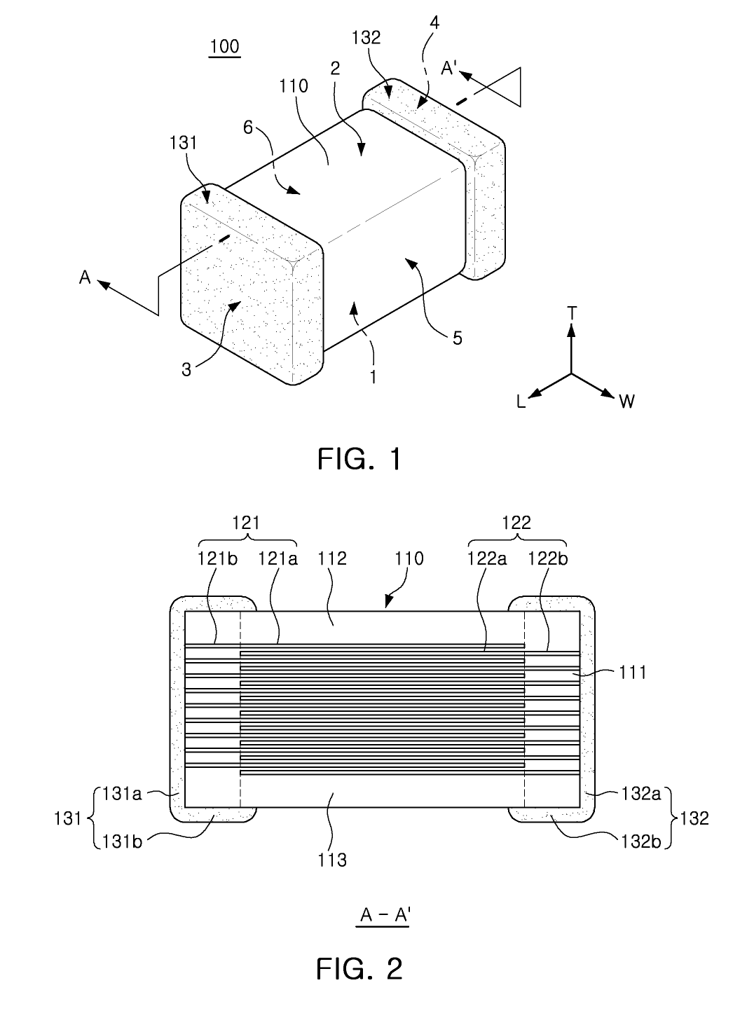

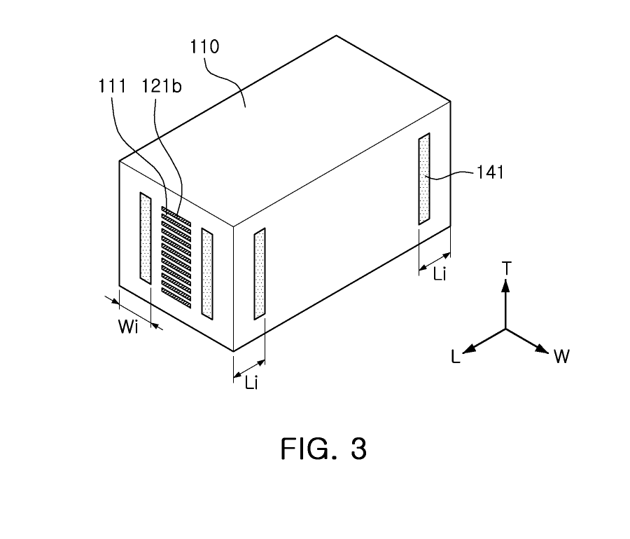

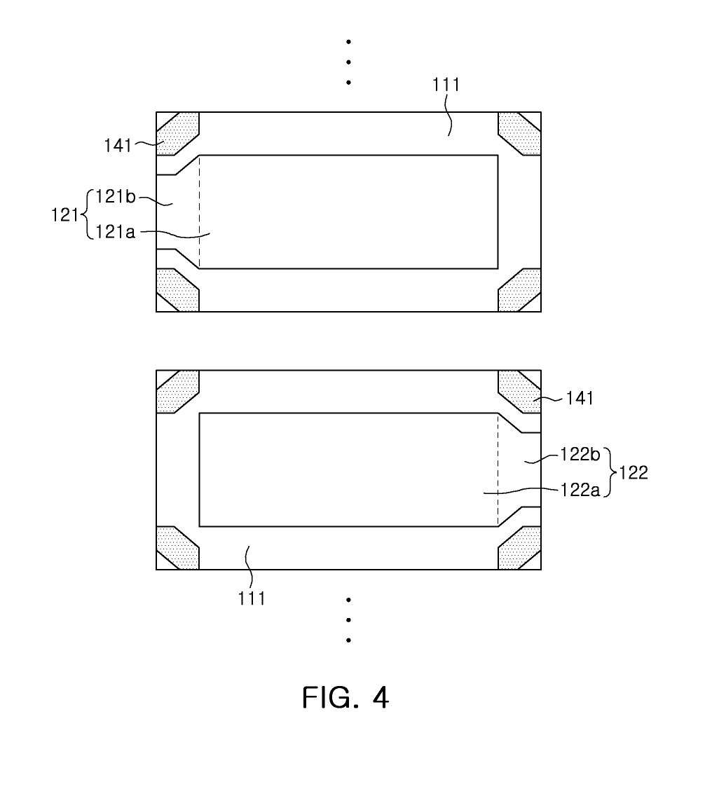

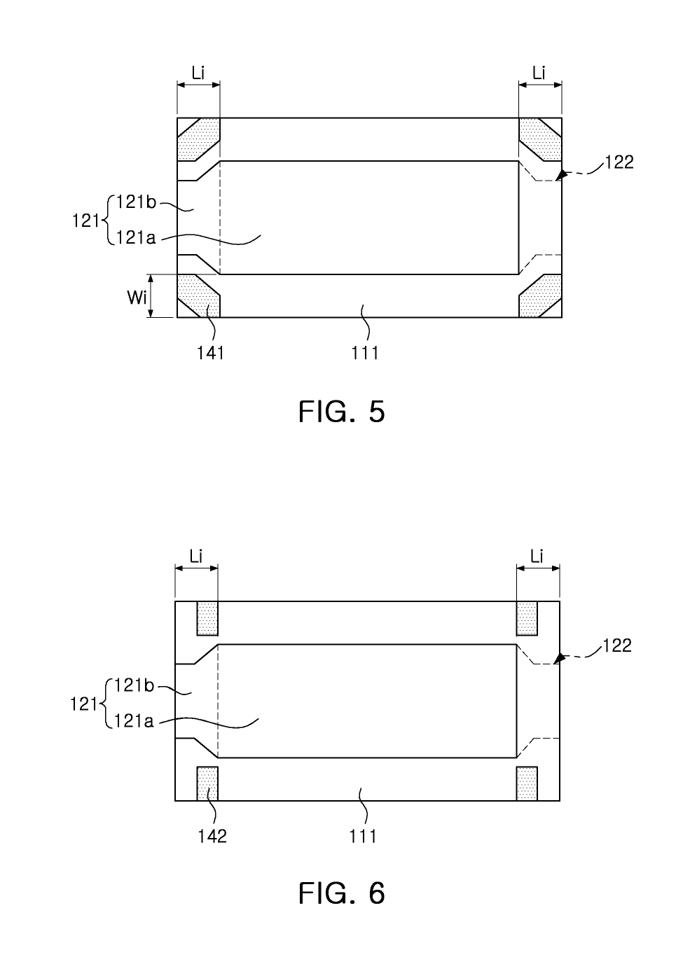

FIG. 1 is a perspective view of a multilayer ceramic electronic component according to an exemplary embodiment, FIG. 2 is a cross-sectional view taken along line A-A′ of FIG. 1, FIG. 3 is a perspective view of the multilayer ceramic electronic component of FIG. 1 in which external electrodes are omitted, FIG. 4 is an exploded plan view of a stacked structure of first and second internal electrodes in FIG. 1, and FIG. 5 is a plan view illustrating first and second internal electrodes overlapping each other in FIG. 1.

In the present exemplary embodiment, for convenience of explanation, “T,” “L,” and “W” in FIG. 1 refer to a thickness direction, a length direction, and a width direction, respectively.

Referring to FIGS. 1 through 5, a multilayer ceramic electronic component 100, according to the present exemplary embodiment, may include a ceramic body 110; first and second internal electrodes 121 and 122; first and second external electrodes 131 and 132, and dummy electrodes 141.

The ceramic body 110 may be formed by stacking a plurality of dielectric layers 111 in the thickness direction and then sintering the stacked dielectric layers 111.

In this case, the respective adjacent dielectric layers 111 of the ceramic body 110 may be integrated with each other so that boundaries therebetween are not readily apparent.

In addition, the ceramic body 110 may have a hexahedral shape. However, a shape of the ceramic body 110 is not limited thereto.

In the present exemplary embodiment, for convenience of explanation, surfaces of the ceramic body 110 opposing each other in the thickness (T) direction in which the dielectric layers 111 are stacked will be defined as first and second surfaces 1 and 2, surfaces of the ceramic body 110 connecting the first and second surfaces 1 and 2 thereof to each other and opposing each other in the length (L) direction will be defined as third and fourth surfaces 3 and 4, surfaces of the ceramic body 110 connecting the third and fourth surfaces 3 and 4 and opposing each other in the width (W) direction will be defined as fifth and sixth surfaces 5 and 6.

Further, an upper cover layer 112 having a predetermined thickness may be formed on the uppermost internal electrode of the ceramic body 110, and a lower cover layer 113 may be formed beneath the lowermost internal electrode of the ceramic body 110.

The upper and lower cover layers 112 and 113 may be formed of the same composition as that of the dielectric layer 111 and may be formed by stacking at least one or more dielectric layers that do not include the internal electrodes on the uppermost internal electrode and beneath the lowermost internal electrode of the ceramic body 110, respectively.

The dielectric layer 111 may contain a ceramic material having high permittivity, such as a BaTiO₃ based ceramic powder. However, a material of the dielectric layer 111 is not limited thereto.

The BaTiO₃-based ceramic powder may be, for example, (Ba₁₋ₓCaₓ)TiO₃, Ba(Ti_{1-y}Ca_{y})O₃, (Ba₁₋ₓCaₓ)(Ti_{1-y}Zr_{y})O₃, or Ba(Ti_{1-y}Zr_{y})O₃ in which calcium (Ca), zirconium (Zr), or the like, and may be partially solid-dissolved in barium titanate (BaTiO₃), or the like, but the BaTiO₃-based ceramic powder is not limited thereto.

In addition, at least one of ceramic additives, an organic solvent, a plasticizer, a binder, and a dispersant may be further contained in the dielectric layer 111.

For the ceramic additive, for example, a transition metal oxide or carbide, rare earth elements, magnesium (Mg), aluminum (Al), or the like, may be used.

After the first and second internal electrodes 121 and 122 are formed on ceramic sheets forming the dielectric layers 111 and stacked, the first and second internal electrodes 121 and 122 may be alternately disposed in the ceramic body 110 with each of the dielectric layers 111 interposed therebetween by sintering.

The first and second internal electrodes 121 and 122 as described above, which are electrodes applied with different polarities from each other, may be disposed to face each other in the stacked direction of the dielectric layers 111, and may be electrically insulated from each other by the dielectric layer 111 disposed therebetween.

In the present exemplary embodiment, the first and second internal electrodes 121 and 122 may have, for example, a bottle neck shape in which widths of portions of the first and second internal electrodes 121 and 122 exposed to the outside of the ceramic body 110 are narrower than that of portions thereof overlapping with each other. This bottle neck structure may decrease generation of cracks and delamination of the internal electrodes.

For this bottle neck structure, the first and second internal electrodes 121 and 122 may include first and second capacitance portions 121a and 122a overlapping each other in a direction perpendicular to a thickness direction and first and second lead portions 121b and 122b, respectively, wherein the first and second lead portions 121b and 122b may have a width narrower than that of the first and second capacitance portions 121a and 122a.

The first and second lead portions 121b and 122b may be portions extended from the first and second capacitance portions 121a and 122a so as to be led to the third and fourth surfaces 3 and 4 of the ceramic body 110 in the length direction, respectively.

The first and second capacitance portions 121a and 122a and the first and second lead portions 121b and 122b may be connected to each other through tapered first and second connection portions, but the first and second capacitance portions 121a and 122a and the first and second lead portions 121b and 122b are not limited thereto. The shapes of the first and second capacitance portions 121a and 122a and the first and second lead portions 121b and 122b may be variously changed. For example, the first and second lead portions 121b and 122b may be stepped at an angle of about 90° with respect to the first and second capacitance portions 121a and 122a.

Describing a case in which a margin portion of the ceramic body is tapered or stepped as described above, in a manufactured multilayer ceramic electronic component, corner portions of a ceramic body may be polished to be rounded as a finishing process. In this case, distances between the corner portion of the ceramic body and internal electrodes may be shortened, and thus electric properties of the electronic component may be deteriorated.

However, when the first and second connection portions, which are sides connecting the first and second capacitance portions 121a and 122a and the first and second lead portions 121b and 122b to each other, are tapered or stepped, the corner portions of the ceramic body 110 and the first and second internal electrodes 121 and 122 may be maintained to have sufficient wide intervals therebetween, and thus a volume of the dielectric material protecting the first and second internal electrodes 121 and 122 may be relatively increased, thereby preventing electric properties of the electronic component from being deteriorated.

In addition, end portions of the first and second lead portions 121b and 122b alternately exposed to the third and fourth surfaces 3 and 4 of the ceramic body 110 in the length direction may come in contact with first and second head portions 131a and 132a of the first and second external electrodes 131 and 132 on the third and fourth surfaces 3 and 4 of the ceramic body 110 in the length direction to thereby be electrically connected thereto, respectively.

The first and second internal electrodes 121 and 122 may be formed of a conductive metal, such as nickel (Ni), a nickel (Ni) alloy, or the like. However, a material of the first and second internal electrodes 121 and 122 is not limited thereto.

Through the above-mentioned configuration, when a predetermined voltage is applied to the first and second external electrodes 131 and 132, electric charges may be accumulated between the first and second internal electrodes 121 and 122 facing each other.

Capacitance of the multilayer ceramic electronic component 100 may be in proportion to an overlapping area between the first and second capacitance portions 121a and 122a overlapping each other in the stacked direction of the dielectric layers 111.

The first and second external electrodes 131 and 132 may be disposed to both end portions of the ceramic body 110 in the length direction, respectively.

The first and second external electrodes 131 and 132 may include the first and second head portions 131a and 132a and first and second band portions 131b and 132b.

The first and second head portions 131a and 132a may be portions coming in contact with exposed end portions of the first and second lead portions 121b and 122b of the first and second internal electrodes 121 and 122 to thereby be electrically connected thereto, respectively, while covering the third and fourth surfaces 3 and 4 of the ceramic body 110 in the length direction, respectively.

The first and second band portions 131b and 132b may be portions extended from the first and second head portions 131a and 132a so as to partially cover circumferential surfaces of the ceramic body 110 and serve to improve adhesion strength between the first and second external electrodes 131 and 132 and the ceramic body 110 and electric connectivity of a product at the time when the electronic component is mounted on a board, or the like.

Plating layers (not illustrated) may be formed on the first and second external electrodes 131 and 132, as needed.

The plating layers may include first and second nickel (Ni) plating layers each formed on the first and second external electrodes 131 and 132 and first and second tin (Sn) plating layers each formed on the first and second nickel plating layers, as an example. However, the plating layers are not limited thereto.

Dummy electrodes 141 may be disposed to be spaced apart from the first and second internal electrodes 121 and 122 at positions of the margin portions of each of the dielectric layers 111 corresponding to the first and second lead portions 121b and 122b of the first and second internal electrodes 121 and 122 in the width direction.

The dummy electrodes 141 may serve to compensate for margins in the width direction, which are relatively increased in accordance with areas of the first and second lead portions 121b and 122b decreased in the first or second internal electrode 121 or 122 by the so-called bottle neck shaped structure (a structure in which the lead portions are narrower than the capacitance portions) as compared to the first and second capacitance portions 121a and 122a.

Therefore, since steps in both margin portions of the ceramic body 110 in the length direction may be decreased by the dummy electrodes 141, generation of cracks and delamination may be decreased, and withstanding voltage characteristics of the product may be improved.

In a multilayer ceramic capacitor according to the related art, after manufacturing a capacitor by cutting a ceramic body of which compression was completed in a manufacturing process, internal electrodes and dielectric layers may be discerned from each other by seeing a cross-sectional surface of the capacitor cut in W-T directions with the naked eye or through imaging thereof, and thus a margin of the capacitor in a width direction may be recognized.

However, when a cross-sectional surface of the capacitor cut in L-T directions is viewed with the naked eye or imaged, only the dielectric layers may be seen, and it may be difficult to discern individual internal electrodes positioned within the ceramic body. Therefore, a margin of the capacitor cut in the length direction may not be able to be used for the sorting of capacitors with the naked eye or imaging.

According to the related art, in order to see the margin of a cross section of the capacitor in the length direction, a method of breaking and cutting a central portion of the capacitor in L-T directions has been used. However, in this case, loss due to breakage of the cut capacitor may occur.

According to the present exemplary embodiment, the dummy electrodes 141 may be exposed to one of the fifth and sixth surfaces 5 and 6 of the ceramic body 110 in the width direction, close to the dummy electrodes 141.

A portion of exposed portions of the dummy electrodes 141 corresponding to an inner end portion of the ceramic body 110 in the length direction may be positioned on the same virtual line as end portions of the first and second capacitance portions 121a and 122a in the length direction.

The portion of the dummy electrodes 141 exposed to the fifth or sixth surface 5 or 6 of the ceramic body 110 may serve as an index of a margin Li of the ceramic body 110 in the length direction.

Therefore, the margin of the multilayer ceramic electronic component 100 in the length direction may be easily confirmed by the portions of the dummy electrodes 141 exposed to the fifth or sixth surface 5 or 6 of the ceramic body 110 with the naked eye or through imaging thereof, in a state in which a central portion of an electronic component, in L-T directions, cut through a cutting process, is not broken.

In addition, due to the above-mentioned structure, productivity may be improved by solving a problem that a capacitor is sorted depending on electric properties thereof after performing post processes such as sintering, an external electrode forming process, a plating process, and the like, on a capacitor that is not broken or cut in a state in which the capacitor is not sorted, and when the capacitor is defective, the capacitor is discarded.

Although a case in which the dummy electrodes 141 are disposed in a vicinity of all of four corner portions of one dielectric layer 111 is illustrated and described in the present exemplary embodiment, the dummy electrodes 141 are not limited thereto. That is, if necessary, the dummy electrodes 141 may be composed of one or two dummy electrodes disposed only in portions adjacent to the first or second lead portion 121b or 122b.

In addition, the dummy electrodes 141 may be exposed to one surface of the third and fourth surfaces 3 and 4 of the ceramic body 110 in the length direction, close to the dummy electrodes 141.

A portion of exposed portions of the dummy electrodes 141 corresponding to an inner end portion of the ceramic body 110 in the width direction may be positioned on the same virtual line as end portions of the first and second capacitance portions 121a and 122a in the width direction.

The portion of the dummy electrodes 141 exposed to the third or fourth surface 3 or 4 of the ceramic body 110 may serve as an index of a margin Wi of the ceramic body 110 in the width direction.

In the present exemplary embodiment, the dummy electrodes 141 may have a configuration similar to a configuration obtained by forming a dummy electrode 141 in a shape of a quadrangle and chamfering one or both of a corner of the quadrangle positioned in the ceramic body 110 and a corner thereof positioned in the corner of the ceramic body 110.

The dummy electrodes 141 may have a hexagon shape, and one side of the hexagon may be exposed to one surface of the ceramic body 110 in the length direction and another side thereof may be exposed to one surface of the ceramic body 110 in the width direction, respectively.

### Modified Exemplary Embodiment

FIG. 6 is a plan view illustrating dummy electrodes of a multilayer ceramic electronic component according to another exemplary embodiment.

Referring to FIG. 6, dummy electrodes 142, according to the present exemplary embodiment, may have a quadrangular shape, and one side of the dummy electrode 142 having the quadrangular shape may be exposed to one surface of fifth and sixth surfaces 5 and 6 of a ceramic body 110 close to the quadrangle. An inner end portion of the exposed side of the dummy electrodes 142 in the length (L) direction may be positioned on the same virtual line as end portions of first and second capacitance portions 121a and 122a in the length direction, thereby serving as an index of a margin Li of the ceramic body 110 in the length direction.

In this case, the dummy electrodes 142 may be disposed not to be exposed to third and fourth surfaces 3 and 4 of the ceramic body 110 in the length direction, and the other side of the dummy electrodes 142 opposing the exposed side thereof may be disposed to be spaced apart from first and second internal electrodes 121 and 122.

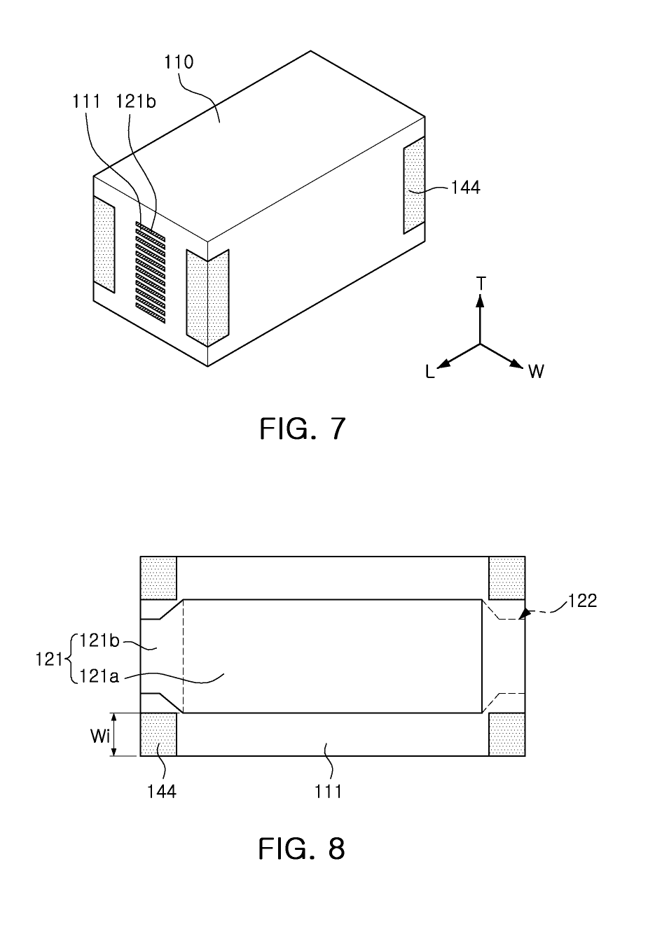

FIGS. 7 and 8 are perspective and plan views illustrating dummy electrodes of a multilayer ceramic electronic component according to another exemplary embodiment.

Referring to FIGS. 7 and 8, dummy electrodes 144, according to the present exemplary embodiment, may have a quadrangular shape, and two sides of the dummy electrode 144 connected to each other may be exposed to a corner of the ceramic body 110 close thereto.

In this case, a length of the dummy electrodes 144 in the length (L) direction may be shorter than that of first and second lead portions 121b and 122b, and thus the dummy electrodes 144 may not come in contact with first and second internal electrodes 121 and 122, and inner end portions of the dummy electrodes 144 exposed to third and fourth surfaces 3 and 4 of the ceramic body 110 in the length (L) direction may be positioned on the same virtual line as end portions of first and second capacitance portions 121b and 122b in the width direction, thereby serving as an index of a margin Wi of the ceramic body 110 in the width direction.

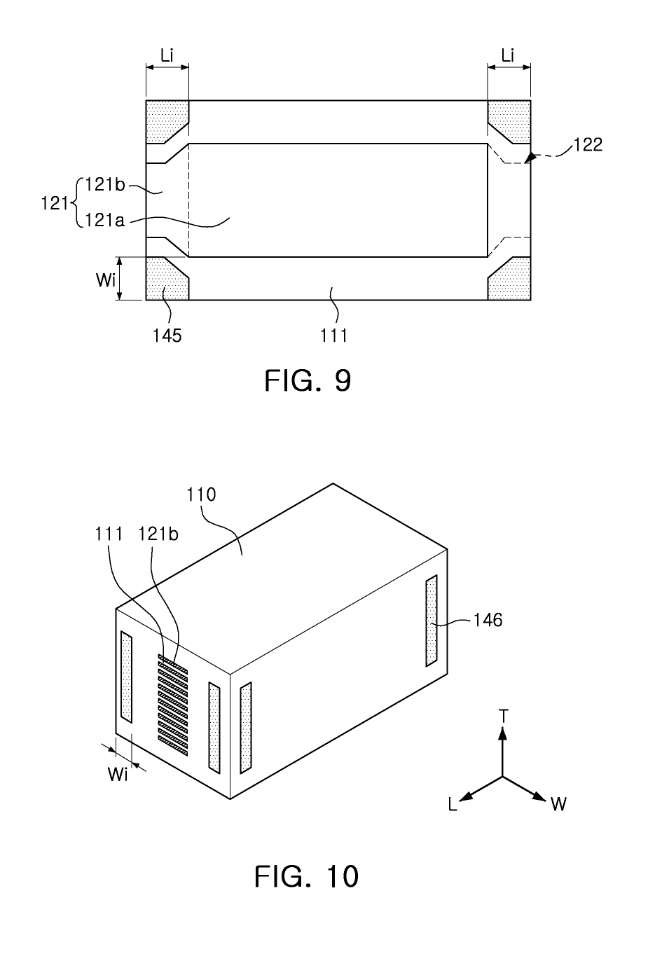

As illustrated in FIG. 9, corners of dummy electrodes 145 positioned in a ceramic body 110 may be chamfered so as to be inclined.

In this case, a length of the dummy electrodes 145 in the length (L) direction may be the same as that of first and second lead portions 121b and 122b, and thus the dummy electrodes 145 may serve as an index of a margin Li of the ceramic body 110 in the length direction.

Further, inner end portions of the dummy electrodes 145 exposed to third and fourth surfaces 3 and 4 of the ceramic body 110 in the length (L) direction may be positioned on the same virtual line as end portions of first and second capacitance portions 121b and 122b in the width direction, thereby serving as an index of a margin Wi of the ceramic body 110 in the width direction.

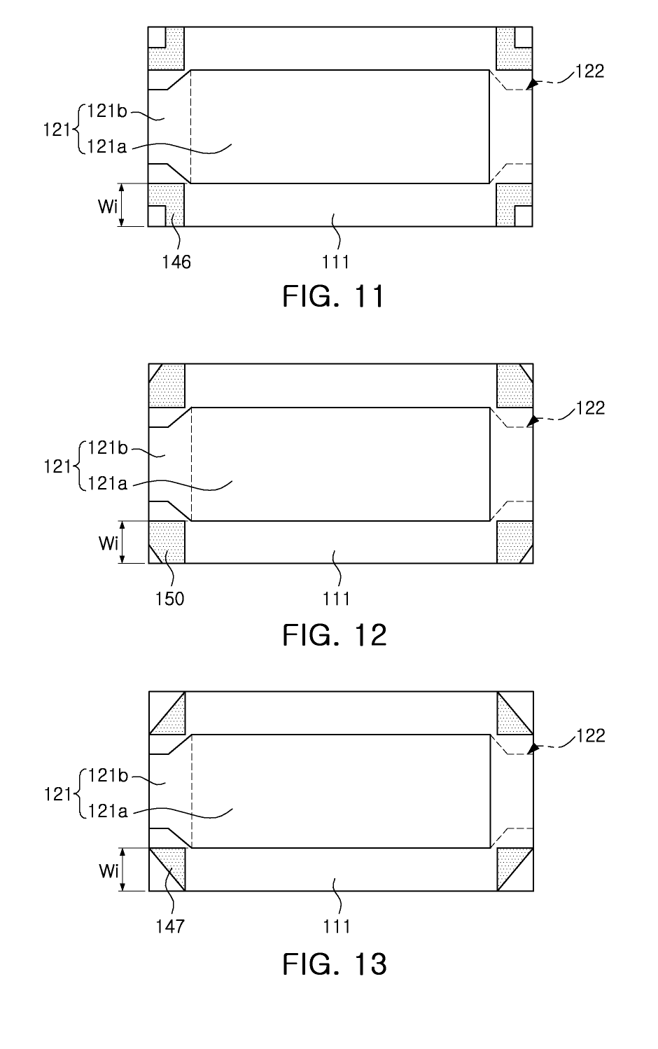

As illustrated in FIGS. 10 and 11, corners of dummy electrodes 146 positioned at corners of a ceramic body 110 may be chamfered, and thus the dummy electrodes 146 may have groove portions.

As illustrated in FIG. 12, if necessary, corners of dummy electrodes 150 positioned at corners of a ceramic body 110 may be chamfered so as to be inclined.

FIG. 13 is a plan view of dummy electrodes of a multilayer ceramic electronic component according to another exemplary embodiment.

Referring to FIG. 13, dummy electrodes 147, according to the present exemplary embodiment, may have a shape of a triangle, and two vertices of the triangle positioned at both ends of a longest side of a triangle may be exposed to one surface of third and fourth surfaces 3 and 4 of a ceramic body 110 in the length direction close to the dummy electrode 147 and exposed to one surface of fifth and sixth surfaces 5 and 6 thereof in the width direction close to the dummy electrode 147, respectively.

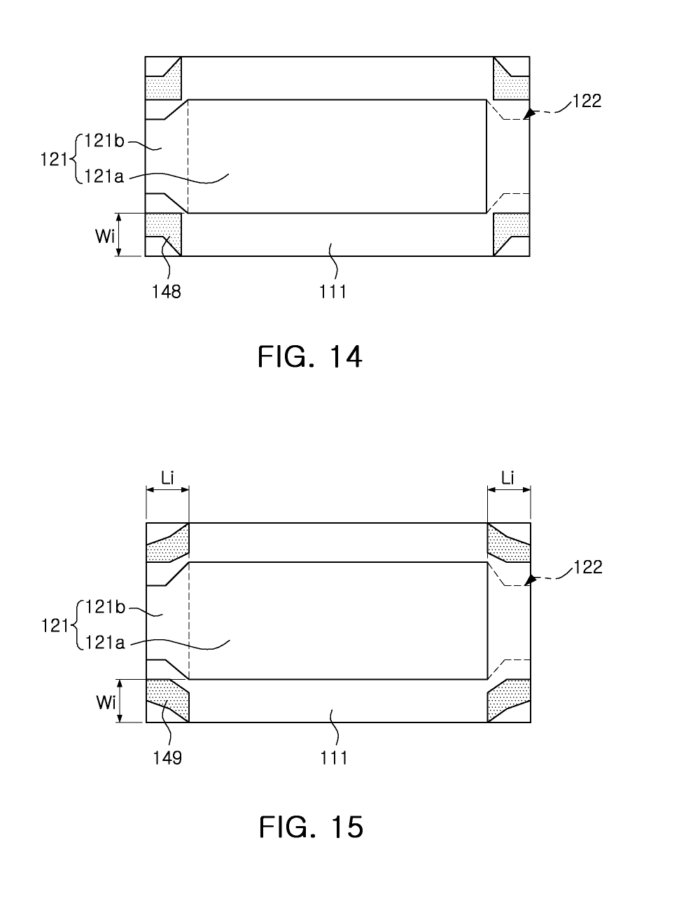

FIGS. 14 and 15 are plan views of dummy electrodes of multilayer ceramic electronic components according to other exemplary embodiments in the present disclosure.

Referring to FIG. 14, dummy electrodes 148 may have a polygonal shape and be exposed to one surface of a ceramic body 110 in the length direction and one surface thereof in the width direction, respectively, but a side of the dummy electrode 148 having the polygonal shape may be exposed to one surface of the ceramic body 110 in the length direction, and a vertex of the dummy electrode 148 having the polygonal shape may be exposed to one surface of the ceramic body in the width direction.

Conversely, if necessary, the dummy electrodes 148 may be formed so that a vertex of the polygon is exposed to one surface of the ceramic body 110 in the length direction, and a side thereof is exposed to one surface of the ceramic body 110 in the width direction.

Further, as illustrated in FIG. 15, corners of dummy electrodes 149 positioned in a ceramic body 110 may be chamfered.

As set forth above, according to exemplary embodiments in the present disclosure, the internal electrodes may include the capacitance portions and the lead portions narrower than the capacitance portions, and thus the step in the margin portion of the ceramic body in the length direction may be decreased, thereby decreasing generation of cracks and delamination, and improving the withstanding voltage characteristics of the product.

While exemplary embodiments have been shown and described above, it will be apparent to those skilled in the art that modifications and variations could be made without departing from the scope of the present invention as defined by the appended claims.

What is claimed is:

1. A multilayer ceramic electronic component comprising:
internal electrodes having lead portions narrower than capacitance portions,
one or more dummy electrodes disposed on margin portions of dielectric layers, each corresponding to one of the lead portions in a width direction and spaced apart from the internal electrodes.

2. The multilayer ceramic electronic component of claim 1, wherein at least one of the one or more dummy electrodes is exposed to one surface of a ceramic body in a width direction, and an inner end portion of an exposed portion of the dummy electrode in a length direction of the ceramic body is positioned on the same virtual line as an end portion of the capacitance portion in the length direction.

3. The multilayer ceramic electronic component of claim 1, wherein at least one of the one or more dummy electrodes is exposed to one surface of a ceramic body in a length direction, and an inner end portion of an exposed portion of the dummy electrode in a width direction of the ceramic body is positioned on the same virtual line as an end portion of the capacitance portion in the width direction.

4. A multilayer ceramic electronic component comprising:
a ceramic body including:
a plurality of dielectric layers, and
first and second internal electrodes alternately disposed to face each other with respective dielectric layers interposed in between, and respectively including first and second capacitance portions overlapping each other and first and second lead portions respectively extended from the first and second capacitance portions to be exposed to respective end surfaces of the ceramic body in a length direction
wherein the first and second lead portions have a width narrower than a width of the first and second capacitance portions;
first and second external electrodes respectively disposed on the end surfaces of the ceramic body in the length direction and connected to the first and second lead portions, respectively; and
one or more dummy electrodes disposed on margin portions of the dielectric layers, each corresponding to one of the first or second lead portions and spaced apart from the first and second internal electrodes, in a width direction of the ceramic body.

5. The multilayer ceramic electronic component of claim 4, wherein the first and second internal electrodes further include first and second connection portions connecting the first and second capacitance portions and the first and second lead portions to each other and formed to be tapered.

6. The multilayer ceramic electronic component of claim 4, wherein at least one of the one or more dummy electrodes is exposed to one surface of the ceramic body in the width direction.

7. The multilayer ceramic electronic component of claim 6, wherein inner end portions of exposed portions of the at least one of the one or more dummy electrodes in the length direction of the ceramic body are positioned on the same virtual line as end portions of the first and second capacitance portions in the length direction.

8. The multilayer ceramic electronic component of claim 4, wherein at least one of the one or more dummy electrodes is exposed to one surface of the ceramic body in the length direction.

9. The multilayer ceramic electronic component of claim 8, wherein an inner end portion of an exposed portion of the at least one of the one or more dummy electrodes in the width direction of the ceramic body is positioned on the same virtual line as end portions of the first and second capacitance portions in the width direction.

10. The multilayer ceramic electronic component of claim 4, wherein at least one of the one or more dummy electrodes is exposed to a corner of the ceramic body.

11. The multilayer ceramic electronic component of claim 4, wherein at least one of the one or more dummy electrodes has a quadrangular shape and is exposed to one surface of the ceramic body in the width direction.

12. The multilayer ceramic electronic component of claim 4, wherein at least one of the one or more dummy electrodes has a quadrangular shape and is exposed to a corner of the ceramic body.

13. The multilayer ceramic electronic component of claim 4, wherein at least one of the one or more dummy electrodes has a quadrangular shape and a chamfered corner.

14. The multilayer ceramic electronic component of claim 4, wherein at least one of the one or more dummy electrodes has a quadrangular shape, and a chamfered corner positioned at a corner of the ceramic body.

15. The multilayer ceramic electronic component of claim 4, wherein at least one of the one or more dummy electrodes has a shape of a triangle, and two vertices positioned at both ends of a longest side of the triangle are exposed to one surface of the ceramic body in the length direction and one surface of the ceramic body in the width direction, respectively.

16. The multilayer ceramic electronic component of claim 4, wherein at least one of the one or more dummy electrodes has a polygonal shape and is exposed to one surface of the ceramic body in the length direction and one surface of the ceramic body in the width direction, and has a groove portion positioned at a corner of the ceramic body.
